(19) United States
(12) Patent Application Publication
(10) Pub. No.: US 2026/0167064 A1
(43) Pub. Date: Jun. 18, 2026

(54) DYNAMIC DAMPING AND SELF-BALANCING AUTOMOTIVE SEAT AND CONTROL METHOD

(71) Applicant: Zhejiang University, Haining (CN)

(72) Inventors: Liangjing YANG, Haining (CN); Yizhou HUANG, Haining (CN); Yilang FENG, Haining (CN); Wentao NI, Haining (CN); Songjie XIAO, Haining (CN)

(73) Assignee: Zhejiang University, Haining (CN)

(21) Appl. No.: 19/534,757

(22) Filed: Feb. 10, 2026

(30) Foreign Application Priority Data
Oct. 29, 2025 (CN) 202511555174.9

(51) Int. Cl. B60N 2/04; B60N 2/90

(52) U.S. Cl. CPC B60N 2/04; B60N 2/90

(57) ABSTRACT

Disclosed is a dynamic damping and self-balancing automotive seat and a control method, pertaining to the field of intelligent seat system design and control technology. The seat comprises a compliant-control push-rod array with a thin film pressure sensor at the top of the push rods. The control method calculates the difference between individual push rod pressure and the array average pressure, and effects stiffness adjustment via PID combined with feedforward amount, calculation of acceleration through admittance control followed by velocity command generation via integration, and output of differential PWM signals from the PD controller to drive the push rods. The present disclosure employs the aforementioned dynamic damping and self-balancing automotive seat and control method to achieve real-time balancing of occupant pressure distribution and dynamic counteraction of road-induced vibrations. Thereby, it overcomes the limitations inherent in conventional seats with fixed support characteristics, and thus enhances ride comfort and stability.

### TECHNICAL FIELD

The present disclosure to the field of intelligent seat system design and control technology, particularly to a dynamic damping and self-balancing automotive seat and control method.

### BACKGROUND

Current dynamic damping and self-balancing control technologies for automotive seats exhibit several limitations. In terms of control methods, while conventional proportional-integral-derivative (PID) control is straightforward to implement, its weak adaptability makes it difficult to grapple with dynamic variations in road conditions and occupant weight. Admittance control, capable of simulating virtual mechanical characteristics, relies heavily on empirical parameter tuning. Moreover, during multi-actuator coordinated adjustment, it is prone to coupling interference, which complicates the establishment of an accurate force-position mapping relationship. Regarding actuators, pneumatic components suffer from response lag due to air compression delays. Electric linear actuators, limited by the inertia of the motor and the transmission mechanism, exhibit insufficient bandwidth for coordinated multi-directional vibration suppression. The single-axis adjustment mode struggles to accommodate complex scenarios such as steering-induced roll, and front-rear oscillation during acceleration or deceleration. Metaheuristic algorithms also present constraints in parameter optimization: genetic algorithms suffer from low iterative efficiency, failing to meet the computational demands of real-time control. Furthermore, conventional optimization strategies lack a dynamic correlation between road condition characteristics and control parameters, making it challenging to simultaneously achieve the dual objectives of vibration compensation and pressure homogenization.

These conventional techniques fall short of meeting the demands for dynamic comfort in automotive seats under complex road conditions. In the present disclosure, the automotive seat and control method are provided to achieve multi-dimensional support adjustment through a compliant-control push-rod module. The dynamic response accuracy is enhanced via a combination of PID and feedforward stiffness adjustment, coupled with an improved admittance control algorithm implemented through field-programmable gate arrays (FPGA) parallel computation. Furthermore, the actuator bandwidth bottleneck is addressed by employing differential pulse width modulation (PWM) drive and high-frequency encoder feedback. Consequently, the present disclosure achieves a dynamically uniform distribution of contact force between the human body and the seat cushion, thereby alleviating vertical vibrations transmitted from the road surface.

### SUMMARY

An objective of the present disclosure is to provide a dynamic damping and self-balancing automotive seat and a control method. To address issues inherent in prior automotive seats, such as fixed support characteristics, difficulty in adapting to road bumps and dynamic changes in occupant posture, resulting in non-uniform contact force distribution and significant vibration transmission. To this end, a dynamically adjustable automotive seat based on a push rod array is provided. By enabling discrete partitioned adjustment of the surface damping and stiffness of the cushion, it solves the problem of non-uniform human-seat contact force under complex road conditions, effectively mitigates the transmission of road-induced vibrations to the occupant, thereby improving the driving comfort.

In order to achieve the above objective, the present disclosure provides a dynamic damping and self-balancing automotive seat, including a cushion and a compliant-control push-rod module arranged inside the cushion, the compliant-control push-rod module includes a push rod array, the push rod array is composed of multiple push rods, and the multiple push rods are vertically distributed in an array manner, a top of the push rod is provided with a thin film pressure sensor, both sides of each column of the push rod are provided with a clamp, and an integrated circuit board is arranged below the clamp, and the thin film pressure sensor is connected to an interface on the integrated circuit board.

A control method for a dynamic damping and self-balancing automotive seat is further provided in the present disclosure, including the following steps:
S1, acquiring a magnitude value |Fₑₓₜ| of top pressure of the push rod in contact with the human body, and an average force F̅ of the push rod array in contact with the human body through the thin film pressure sensor, and collecting a real-time position x and a real-time velocity \dot{x} of the push rod through an encoder integrated with the push rods;
S2, inputting the magnitude value |Fₑₓₜ| of the top pressure of the push rod, the position x of the push rod, and the average force F of the push rod array in contact with the human body acquired in step S1 to a variable stiffness control, and calculating a stiffness K_{d} by the variable stiffness control;
S3, inputting the stiffness K_{d} and the magnitude value |Fₑₓₜ| of the top pressure of the push rod, the position x and the velocity \dot{x} of the push rod acquired in step S1 to an admittance controller, and calculating and outputting a velocity command \dot{x}_{adm} to the velocity controller by the admittance controller;
S4, inputting the velocity command \dot{x}_{adm} calculated by the admittance controller and the position x of the push rod acquired in step S1 to a velocity controller, and calculating and outputting two differential PWM signals Fₑ by the velocity controller; and
S5, returning to step S1 and proceeding a next program loop.

In some embodiments, in step S1, a process of acquiring the magnitude value |Fₑₓₜ| of the top pressure of the push rod includes:
when an unknown environment or human body acts on the push rod array, occurring changes in an output voltage of the thin film pressure sensor at the top of the push rod under pressure;
synchronously receiving voltages of each thin film pressure sensor filtered by a voltage dividing circuit of the thin film pressure sensor on the integrated circuit board through a NIC series analog input acquisition card of an embedded master controller; and
finally, calculating a voltage signal as the magnitude value |Fₑₓₜ| of the top pressure of the push rod.

In some embodiments, in step S1, a process of acquiring the position x and the velocity \dot{x} of the push rod includes:
outputting a two phase difference square wave signal by the encoder of the push rod;
processing the square wave signal by an encoder signal amplification and filtering circuit of the integrated circuit board;
reading the processed square wave signal by a NIC series digital input/output card of the embedded master controller; and
according to the phase difference and a period of the two square waves, calculating the position x and the velocity \dot{x} of the push rod.

In some embodiments, in step S2, a process of calculating the stiffness K_{d} includes:
calculating a difference value ΔF=Fᵢ−F̅ between a human contact force Fᵢ of a single push rod and the average force F̅ of the push rod array in contact with the human body;
inputting the difference value ΔF into a PID controller and outputting a PID adjustment amount;
adding the PID adjustment amount to a feedforward amount used to maintain an initial support configuration of the push rod array; and
calculating the stiffness K_{d} from the above superposition results.

In some embodiments, in step S3, a calculation formula of the admittance controller is:

$$M {\ddot{x}}_{adm} = {K}_{d} ( {x}_{0} - x ) + D ( {\dot{x}}_{0} - \dot{x} ) - \vert {F}_{ext} \vert ; \qquad ( 1 )$$

where x₀ denotes a target position when the push rod is not under pressure, \dot{x}₀ denotes a target velocity when the push rod is not under pressure, x denotes a real-time position of the push rod, \dot{x} denotes a real-time velocity of the push rod, M denotes a mass coefficient, D denotes a damping coefficient, and \ddot{x}_{adm} denotes an acceleration command, and ï_{adm} is integrated to obtain the velocity command \dot{x}_{adm} and output to the velocity controller.

In some embodiments, in step S4, the velocity controller is a proportional-derivative (PD) controller, and the control logic thereof is: receiving the velocity command \dot{x}_{adm} output in step S3 and the real-time velocity \dot{x} of the push rod obtained in step S1, and outputting two differential PWM signals Fₑ after being calculated by the PD control algorithm, wherein a duty cycle of the PWM signals corresponds to the amplitude of the real-time velocity \dot{x} of the push rod, and a positive and negative relationship between the two PWM signals corresponds to a movement direction of the real-time velocity \dot{x} of the push rod; the PWM signal is transmitted to a motor of the push rod via the NIC series digital input/output card.

Accordingly, the present disclosure employs the control method for a dynamic damping and self-balancing automotive seat. By using a push rod array as the seat cushion support and push rods integrated with thin film pressure sensors, discrete partition-based adjustment of physical characteristics like damping and stiffness is achieved, thereby significantly enhancing the dynamic adaptation capability of the seat. Firstly, the variable stiffness control, based on single-point pressure signals, enables real-time optimization of the contact force distribution between the occupant and the seat. This effectively mitigates localized pressure concentration during road bumps, thereby improving ride fit and comfort. Secondly, by individually adjusting the damping and stiffness characteristics of each push rod, the system can accurately counteract road-induced vibration energy across different frequencies and directions. This action reduces the transmission efficiency of vibrations to the human body. Furthermore, the discrete adjustment design accommodates occupants of varying weights and sitting postures, as well as complex dynamic scenarios such as rapid acceleration and steering. When integrated with the closed-loop control logic of pressure sensing and adjustment, it achieves a rapid response from pressure detection to characteristic modulation, which addresses the core technical limitations of conventional seats, such as fixed support characteristics and an inability to dynamically adapt to changing road conditions and occupant postures, thereby comprehensively improving overall driving comfort and stability.

Further detailed descriptions of the technical scheme of the present disclosure can be found in the accompanying drawings and embodiments.

### BRIEF DESCRIPTION OF THE DRAWINGS

FIG. 1 is a schematic diagram of a system application scenario according to an embodiment of the present disclosure;

FIG. 2 is a schematic diagram of a device component decomposition according to an embodiment of the present disclosure;

FIG. 3 is a hardware system architecture diagram according to an embodiment of the present disclosure;

FIG. 4 is a block diagram of a control logic principle according to an embodiment of the present disclosure;

### REFERENCE NUMERALS IN FIGURES

4, a compliant-control push-rod module; 401, a thin film pressure sensor; 402, a push rod; 403, an integrated circuit board; 404, a clamp.

### DETAILED DESCRIPTION OF THE EMBODIMENTS

The technical scheme of the present disclosure is further explained below by drawings and embodiments.

Unless otherwise defined, the technical or scientific terms used in the present disclosure shall be those to which the present disclosure belongs. As used herein, the terms “first”, “second”, and the like do not denote any order, quantity, or importance, but rather are used to distinguish one element from another. Similar words such as “comprise” or “include” means that the elements or items preceding the word encompass the elements or items listed after the word and equivalents thereof, but do not exclude other elements or items. The terms “connection” or “interconnection” are not limited to physical or mechanical connections but may also encompass electrical connections, whether direct or indirect. “Up”, “down”, “left”, “right”, etc. are only used to indicate a relative positional relationship, which may change accordingly when the absolute position of the object being described changes.

### Embodiment

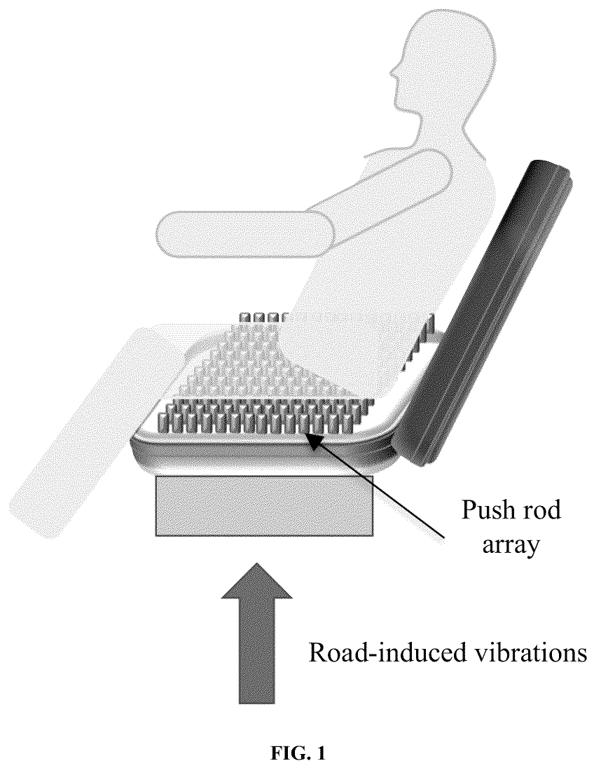

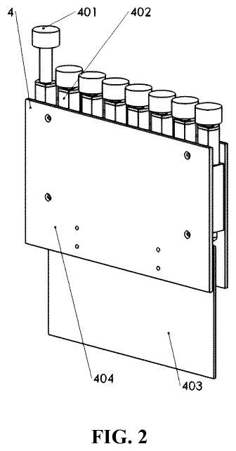

As shown in FIGS. 1-2, a dynamic damping and self-balancing automotive seat, including the cushion and the compliant-control push-rod module 4 arranged inside the cushion, the compliant-control push-rod module 4 includes the push rod array, the push rod array is composed of multiple push rods 402, and the multiple push rods 402 are vertically distributed in an array manner, the top of the push rod 402 is provided with the thin film pressure sensor 401, both sides of each column of the push rod 402 are provided with the clamp 404, and the integrated circuit board 403 is arranged below the clamp 404, and the thin film pressure sensor 401 is connected to the interface on the integrated circuit board 403.

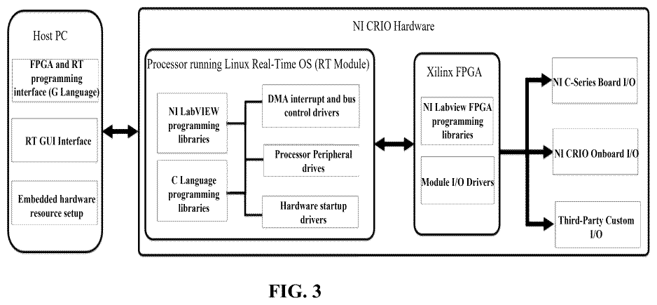

A control method for the dynamic damping and self-balancing automotive seat, the hardware system architecture is shown in FIG. 3. The embedded master control is developed utilizing NI CRIO hardware and the LabVIEW G language programming environment. The host computer PC layer, developed in Lab VIEW G language, operates the FPGA and real-time (RT) programming environments. It is responsible for algorithm development interfaces, RT graphical user interfaces (GUI), and cross-layer communication. Notably, the RT GUI enables monitoring and parameter adjustment of the program executing on the Xilinx FPGA within the NI CRIO. The NI CRIO hardware layer integrates a processor module and an Xilinx FPGA module. The processor module runs the Linux Real-Time OS. The software framework leverages the NI Lab VIEW programming library to implement DMA interrupt management and bus control driver development, while processor peripheral drivers and hardware startup drivers are developed using C language libraries. The Xilinx FPGA module is responsible for controlling individual push rods and executing the seat's push-rod-array-based control method. Core algorithms, such as admittance control and speed PID, are compiled into hardware description language using the NI Lab VIEW FPGA programming library. This leverages the FPGA's parallel computing capability to achieve the acquisition of pressure signals and the output of PWM drive signals. All related sensors and control signals are accomplished through NIC-series input/output (I/O) cards.

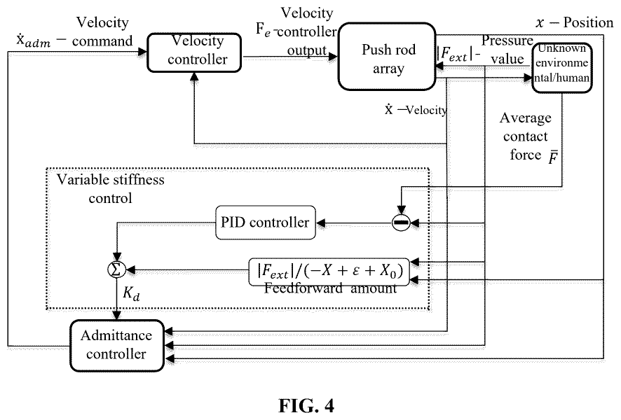

As shown in FIG. 4, the control method for the dynamic damping and self-balancing automotive seat includes the following steps:

S1, the magnitude value |Fₑₓₜ| of top pressure of the push rod 402 in contact with the human body, and the average force F̅ of the push rod array in contact with the human body are acquired through the thin film pressure sensor 401, and the real-time position x and the real-time velocity \dot{x} of the push rod 402 are collected through the encoder integrated with the push rods 402; the above signals are processed by the filter circuit of the integrated circuit board and transmitted to a seat control unit.

The process of acquiring the magnitude value |Fₑₓₜ| of the top pressure of the push rod 402 includes:
when the unknown environment or human body acts on the push rod array, changes occur in the output voltage of the thin film pressure sensor 401 at the top of the push rod 402 under pressure;
the voltages of each thin film pressure sensor filtered are synchronously received by the voltage dividing circuit of the thin film pressure sensor on the integrated circuit board 403 through the NIC series analog input acquisition card of the embedded master controller; and
finally, the voltage signal is calculated as the magnitude value |Fₑₓₜ| of the top pressure of the push rod 402.

The process of acquiring the position x and the velocity \dot{x} of the push rod 402 includes:
the two phase difference square wave signal is output by the encoder of the push rod 402;
the square wave signal is processed by the encoder signal amplification and filtering circuit of the integrated circuit board 403;
the processed square wave signal is read by the NIC series digital input/output card of the embedded master controller; and
according to the phase difference and the period of the two square waves, the position x and the velocity \dot{x} of the push rod 402 are calculated.

S2, the magnitude value |Fₑₓₜ| of the top pressure of the push rod 402, the position x of the push rod 402, and the average force F̅ of the push rod array in contact with the human body acquired in step S1 are input to the variable stiffness control, and the stiffness K_{d} is calculated by the variable stiffness control.

The process of calculating the stiffness K_{d} includes:
the difference value ΔF=Fᵢ−F̅ between the human contact force Fᵢ of the single push rod 402 and the average force F̅ of the push rod array in contact with the human body is calculated;
the difference value ΔF is input into the PID controller, and the PID adjustment amount is output;
the PID adjustment amount is added to the feedforward amount used to maintain the initial support configuration of the push rod array; and
the stiffness K_{d} is calculated from the above superposition results.

S3, the stiffness K_{d} and the magnitude value |Fₑₓₜ| of the top pressure of the push rod 402, the position x and the velocity \dot{x} of the push rod 402 acquired in step S1 are input to the admittance controller, and the admittance controller calculates and outputs the velocity command \dot{x}_{adm} to the velocity controller.

The calculation formula of the admittance controller is:

$$M {\ddot{x}}_{adm} = {K}_{d} ( {x}_{0} - x ) + D ( {\dot{x}}_{0} - \dot{x} ) - \vert {F}_{ext} \vert ; \qquad ( 1 )$$

where x₀ denotes the target position when the push rod 402 is not under pressure, \dot{x}₀ denotes the target velocity when the push rod 402 is not under pressure, x denotes the real-time position of the push rod 402, \dot{x} denotes the real-time velocity of the push rod 402, M denotes the mass coefficient, D denotes the damping coefficient, and \ddot{x}_{adm} denotes the acceleration command, and ï_{adm} is integrated to obtain the velocity command \dot{x}_{adm} and output to the velocity controller.

S4, the velocity command \dot{x}_{adm} calculated by the admittance controller and the position x of the push rod 402 acquired in step S1 are input to the velocity controller, and the velocity controller calculates and outputs two differential PWM signals Fₑ.

Specifically, the velocity controller is the PD controller, and the control logic thereof is: the velocity command \dot{x}_{adm} output in step S3 and the real-time velocity \dot{x} of the push rod 402 obtained in step S1 are received, and two differential PWM signals Fₑ is output after being calculated by the PD control algorithm, wherein the duty cycle of the PWM signals corresponds to the amplitude of the real-time velocity \dot{x} of the push rod 402, and the positive and negative relationship between the two PWM signals corresponds to the movement direction of the real-time velocity \dot{x} of the push rod 402; the PWM signal is transmitted to the motor of the push rod 402 via the NIC series digital input/output card.

Upon receiving the PWM signal, the motor of the push rod 402 drives extension or retraction of the push rod 402. Within the push rod array, each push rod 402 independently adjusts its stroke based on contact pressure differences, forming a support surface that dynamically conforms to the occupants. By altering the stiffness and damping characteristics at each contact point in real time, two primary objectives are achieved: firstly, it disperses vibrational energy transmitted from bumpy road surfaces, thereby attenuating its transmission to the human body; secondly, it balances the contact pressure distribution between the occupant and the seat to prevent localized stress concentration. The thin film pressure sensor 401 on the top of each push rod 402 continuously acquires the contact force signal and feeds this data to the control unit, initiating the next cycle. This process establishes a closed-loop of perception, adjustment, and feedback, achieving the damping and self-balancing effect under complex road conditions.

Therefore, the present disclosure employs the control method for the dynamic damping and self-balancing automotive seat. By using the push rod array as the seat cushion support and push rods integrated with thin film pressure sensors, discrete partition-based adjustment of physical characteristics like damping and stiffness is achieved, thereby significantly enhancing the dynamic adaptation capability of the seat. Firstly, the variable stiffness control, based on single-point pressure signals, enables real-time optimization of the contact force distribution between the occupant and the seat. This effectively mitigates localized pressure concentration during road bumps, thereby improving ride fit and comfort. Secondly, by individually adjusting the damping and stiffness characteristics of each push rod, the system can accurately counteract road-induced vibration energy across different frequencies and directions. This action reduces the transmission efficiency of vibrations to the human body. Furthermore, the discrete adjustment design accommodates occupants of varying weights and sitting postures, as well as complex dynamic scenarios such as rapid acceleration and steering. When integrated with the closed-loop control logic of pressure sensing and adjustment, it achieves the rapid response from pressure detection to characteristic modulation, which addresses the core technical limitations of conventional seats, such as fixed support characteristics and the inability to dynamically adapt to changing road conditions and occupant postures, thereby comprehensively improving overall driving comfort and stability.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A control method for a dynamic damping and self-balancing automotive seat, comprising the following steps:
S1, acquiring a magnitude value |Fₑₓₜ| of top pressure of a push rod in contact with a human body, and an average force F̅ of a push rod array in contact with the human body through a thin film pressure sensor, and collecting a real-time position x and a real-time velocity \dot{x} of the push rod through an encoder integrated with the push rods;
S2, inputting the magnitude value |Fₑₓₜ| of the top pressure of the push rod, the position x of the push rod, and the average force F̅ of the push rod array in contact with the human body acquired in step S1 to a variable stiffness control, and calculating a stiffness K_{d} by the variable stiffness control;
S3, inputting the stiffness K_{d} and the magnitude value |Fₑₓₜ| of the top pressure of the push rod, the position x and the velocity \dot{x} of the push rod acquired in step S1 to an admittance controller, and calculating and outputting a velocity command \dot{x}_{adm} to a velocity controller by the admittance controller;
S4, inputting the velocity command \dot{x}_{adm} calculated by the admittance controller and the position x of the push rod acquired in step S1 to the velocity controller, and calculating and outputting two differential PWM signals Fₑ by the velocity controller;
wherein the velocity controller is a PD controller, and a control logic thereof is: receiving the velocity command \dot{x}_{adm} output in step S3 and the real-time velocity \dot{x} of the push rod obtained in step S1, and outputting the two differential PWM signals Fₑ after being calculated by a PD control algorithm, wherein a duty cycle of the PWM signals corresponds to an amplitude of the real-time velocity \dot{x} of the push rod, and a positive and negative relationship between the two PWM signals corresponds to a movement direction of the real-time velocity \dot{x} of the push rod; wherein the PWM signal is transmitted to a motor of the push rod via a NIC series digital input/output card; and
S5, returning to step S1 and proceeding a next program loop.

2. The control method for a dynamic damping and self-balancing automotive seat according to claim 1, wherein in step S1, a process of acquiring the magnitude value |Fₑₓₜ| of the top pressure of the push rod comprises:
when an unknown environment or human body acts on the push rod array, inducing changes in an output voltage of the thin film pressure sensor at the top of the push rod under pressure;
synchronously receiving voltages of each thin film pressure sensor filtered by a voltage dividing circuit of the thin film pressure sensor on the integrated circuit board through a NIC series analog input acquisition card of an embedded master controller; and
finally, calculating a voltage signal as the magnitude value |Fₑₓₜ| of the top pressure of the push rod.

3. The control method for a dynamic damping and self-balancing automotive seat according to claim 1, wherein in step S1, a process of acquiring the position x and the velocity \dot{x} of the push rod comprises:
outputting a two phase difference square wave signal by the encoder of the push rod;
processing the square wave signal by an encoder signal amplification and filtering circuit of the integrated circuit board;
reading the processed square wave signal by the NIC series digital input/output card of the embedded master controller; and
according to the phase difference and a period of the two square waves, calculating the position x and the velocity \dot{x} of the push rod.

4. The control method for a dynamic damping and self-balancing automotive seat according to claim 1, wherein in step S2, a process of calculating the stiffness K_{d} comprises:
calculating a difference value ΔF=Fᵢ−F̅ between a human contact force Fᵢ of a single push rod and the average force F̅ of the push rod array in contact with the human body;
inputting the difference value ΔF into a PID controller, and outputting a PID adjustment amount;
adding the PID adjustment amount to a feedforward amount used to maintain an initial support configuration of the push rod array; and
calculating the stiffness K_{d} from the above superposition results.

5. The control method for a dynamic damping and self-balancing automotive seat according to claim 1, wherein in step S3, a calculation formula of the admittance controller is:
$$M {\ddot{x}}_{adm} = {K}_{d} ( {x}_{0} - x ) + D ( {\dot{x}}_{0} - \dot{x} ) - \vert {F}_{ext} \vert \qquad ( 1 )$$
where x₀ denotes a target position when the push rod is not under pressure, \dot{x}₀ denotes a target velocity when the push rod is not under pressure, M denotes a mass coefficient, D denotes a damping coefficient, and \ddot{x}_{adm} denotes an acceleration command, and \ddot{x}_{adm} is integrated to obtain the velocity command \dot{x}_{adm} and output to the velocity controller.

6. A dynamic damping and self-balancing automotive seat, capable of operating according to the control method for a dynamic damping and self-balancing automotive seat according to claim 1, comprising a cushion and a compliant-control push-rod module arranged inside the cushion, wherein the compliant-control push-rod module comprises the push rod array, the push rod array is composed of a plurality of push rods, and the a plurality of push rods are vertically distributed in an array manner, wherein a top of the push rod is provided with the thin film pressure sensor, both sides of each column of the push rod are provided with a clamp, and the integrated circuit board is arranged below the clamp, and the thin film pressure sensor is connected to an interface on the integrated circuit board.
